(19) United States
(12) Patent Application Publication
(10) Pub. No.: US 2012/0222378 A1
(43) Pub. Date: Sep. 6, 2012

(54) FLOOR PANEL AND METHODS FOR MANUFACTURING FLOOR PANELS

(75) Inventors: Mark Cappelle, Staden (BE); Benny Schacht, Vlamertinge (BE)

(73) Assignee: FLOORING INDUSTRIES LIMITED, SARL, Bertrange (LU)

(21) Appl. No.: 13/509,395

(22) PCT Filed: Nov. 9, 2010
(86) PCT No.: PCT/IB2010/055086

§ 371 Date: May 11, 2012

Related U.S. Application Data
(60) Provisional application No. 61/297,375, filed on Jan. 22, 2010.

(30) Foreign Application Priority Data
Nov. 20, 2009 (BE) BE2009/0721

(51) Int. Cl. E04B 5/00; B26D 1/62; E04C 2/20

(52) U.S. Cl. 52/309.1; 52/588.1; 408/1 R

(57) ABSTRACT

Floor panel, which, at least at two opposite edges, is provided with coupling means allowing to couple two of such floor panels to each other at the respective edges, such that the respective floor panels, in the coupled condition, are locked in a vertical direction perpendicular to the plane of the coupled floor panels, as well as in a horizontal direction perpendicular to the respective edges and in the plane of the coupled floor panels, wherein the locking in at least one of the aforementioned directions is obtained by at least an element which preferably is resilient and, during the coupling movement, moves in the direction of the edges concerned.

This invention relates to floor panels as well as to methods for manufacturing them.

In particular, this invention relates to floor panels with which a floor covering can be formed by interconnecting two of such floor panels in a glueless manner. To this aim, the floor panels concerned, at least at two opposite edges, are provided with coupling means, by which at the edges concerned a locking between two floor panels can be obtained in a vertical direction perpendicular to the plane of the floor panels, as well as in a horizontal direction perpendicular to the respective edge and in the plane of the respective floor panels. Such coupling means are known as such, for example, from WO 97/47834 or from EP 1 304 427 and substantially consist of a male coupling part, which is provided at least at one of the respective edges and can be brought, by means of a coupling movement, into a female coupling part, which is provided at the opposite edge of a similar floor panel. According to the state of the art, for the coupling movement use can be made of a turning movement along the respective edge, of a shifting movement of the coupling parts towards each other in a horizontal direction, or of a downward movement of the male coupling part in the direction of the female coupling part.

In the case that the coupling parts allow a downward coupling movement of the male coupling part in the female coupling part, the floor panels from the state of the art also allow that these coupling parts can be provided in each other by a so-called fold-down movement (English: fold-down movement) or scissor-like movement. Such fold-down movement or scissor-like movement is described, for example, in WO 2006/043893. By this, it is meant that the respective coupling means are provided in each other by means of a turning movement along an axis transverse to the respective edges. This turning movement may be, for example, a turning movement, which is applied for providing the coupling parts at another pair of opposite edges in each other.

Coupling parts or coupling means, which can be provided in each other by means of a downward coupling movement, possibly may be provided with a separate locking element, which is arranged in one of the respective edges and, when performing the coupling movement, automatically provides for a locking action. Such coupling means are known, for example, from the aforementioned WO 2006/043893. Herein, the locking action is created in that the separate locking elements temporarily can move away in said horizontal direction and, after the end of the coupling movement, automatically move back in order to assume a final position where they cooperate with the coupling part provided at an opposite edge of a similar floor panel, by which a vertical locking is realized between the respective edges. It is suggested that the known floor panels, which are equipped with such coupling means, offer a gain in time when installing them, in comparison to coupling means which do not allow such downward coupling movement. However, they have the disadvantage that the obtained vertical locking leaves much to be desired. According to the state of the art, the possibility of the downward movement, however, requires a certain loss of strength of the vertical locking. Moreover, the movement in horizontal direction requires an additional recess in the profile of the coupling means, which may weaken the final locking to a considerable extent and/or can lead to undesired effects, such as upright edges. This latter is a risk in particular when such locking system is applied in thin floor panels having, for example, a thickness of less than 10 millimeters. Said upright edges form a particular obstacle with floor panels having a relatively thin top layer at their decor side, such as a laminate or veneer top layer. Such top layer namely usually has a thickness of 1 millimeter or less, or even of 0.4 millimeters or less.

From the state of the art, for example, from WO 2007/004960, also floor panels with coupling means are known, wherein the vertical locking between floor panels of a certain row of floor panels in a floor covering is not performed automatically, but is only obtained when installing a subsequent row. This takes place in that the panels of this subsequent row activate a locking strip. In theory, such floor panels allow a stronger vertical locking. However, they strongly depend on the precision of such connection. For example, in some cases the starting position of the separate strip must be precisely determined. The lack of an automatic locking leads to problems, for example, in connection with the locking of the last row. Also when subdividing such floor panels, in particular in a direction transverse to the strip, or when unlocking and re-installing such floor panels, the starting position of the strip can get lost and cause problems.

In the first place, the present invention aims at alternative floor panels, which, according to different preferred embodiments, offer a solution for the problems of the state of the art. So, for example, floor panels can be achieved showing a strong vertical locking, which still allow a fold-down movement.

To this aim, the invention, according to its first independent aspect, relates to a floor panel, which, at least at two opposite edges, is provided with coupling means or coupling parts allowing to couple two of such floor panels to each other at the respective edges, such that the respective floor panels, in the coupled condition, are locked in a vertical direction perpendicular to the plane of the coupled floor panels, as well as in a horizontal direction perpendicular to the respective edges and in the plane of the coupled floor panels, with the characteristic that the locking in at least one of the aforementioned directions is obtained by at least an element which preferably is resilient and, during the coupling movement, moves in the direction of the edge concerned. By this, it is meant that the respective element performs a movement having at least a component in the direction concerned. Preferably, the movement substantially occurs in this direction, and/or at least the displacement in the direction concerned is the largest. Herein, this may relate to a substantially purely translational movement or to a rotational movement. In each case, a displacement of the element concerned is obtained in a direction substantially parallel to the respective edges. Preferably, this relates to a movement in a direction situated in the plane of the coupled floor panels.

Preferably, this relates to a movement which is performed automatically, this means, without having to apply auxiliary means for this purpose. By auxiliary means, in this case also one or more panels of an adjacent, whether or not already installed, row are understood. In the case of a resilient element, the obtained resilience preferably is independent of panels of such adjacent row, or still better a similar or equal movement of the respective element is obtained with an absence as well as with a presence of panels in adjacent rows. The respective edges and the coupling means integrated there in such case thus independently lead to said movement of the element along the edges concerned.

By means of the invention, an extra recess in the profiles of the coupling means can be avoided, as a possible movement of the aforementioned element in horizontal direction can be minimized or even excluded.

Preferably, the invention is applied with thin floor panels having, for example, a thickness of less than 10 millimeters, or still better having a thickness of 5 to 8 millimeters. With these floor panels, it is of interest to exclude as many as possible unnecessary weakenings of the locking.

Preferably, the invention is applied for floor panels having a relatively thin top layer at their decor side, such as a laminate or veneer top layer. Preferably, it relates to floor panels with a top layer having a thickness of 1 millimeter or less, or even of 0.4 millimeters or less. Here, too, it is of interest to avoid cutting below the top layer as much as possible, as this might lead to upright standing edges, which in their turn then may lead to accelerated wear of the top layer.

Preferably, said preferably resilient element in coupled condition at least partially provides for said locking in vertical direction. Namely, the invention allows obtaining a more stable and/or stronger vertical locking by such element than this was the case with the floor panels from the state of the art. To wit, the quality of the vertical locking for a major part depends on the extent of the locking surfaces which are active in vertical direction. By means of the invention, it is possible to realize considerably larger contact surfaces in this direction. Preferably, said vertical locking substantially, and still better entirely, is realized by the respective element, which means that a vertical locking will be seriously subverted or even will be impossible in the absence of the element.

It is not excluded that such preferably resilient element at least partially provides for said locking in horizontal direction. Possibly, the element concerned may participate in the vertical as well as in the horizontal locking.

It is clear that the aforementioned coupling means of said two opposite edges preferably substantially are realized as a male coupling part and a female coupling part, wherein the male coupling part is provided in the female coupling part during the coupling movement.

Further, it is clear that said coupling movement preferably relates to a downward movement of the one floor panel in respect to the other.

Preferably, the aforementioned preferably resilient element, during the coupling movement, will move twice in the direction of the edge concerned, wherein these two movements preferably will be opposed. In the case that such element is applied with rectangular panels, wherein the element of the invention is applied at a first pair of opposite edges and at the other, second pair of opposite edges, male and female coupling parts are provided, the first of said two movements preferably relates to a movement towards the female coupling part of the second pair of edges, whereas the second movement then relates to a movement towards the male coupling part of the second pair of edges. With a usual installation, an installed panel is already coupled to the male coupling part of the aforementioned second pair of edges. With the present preferred embodiment, it is obtained that the space is used which is present in the direction of the female coupling part of the second pair of edges, to which usually no further panels have been coupled yet.

Preferably, the aforementioned preferably resilient element is connected to one of the aforementioned edges and, during the coupling movement, engages in a locking groove which is realized transverse to said horizontal direction.

According to an important embodiment, the aforementioned preferably resilient element forms part of a separate strip, which is provided on one of the edges of the floor panel. The strip concerned can be connected to the respective edge, whether or not in a detachable or removable manner. Preferably, said strip is provided with a plurality of such preferably resilient elements. In such case, it is also possible that the elements move dependently as well as independently from each other. It is also possible that at one and the same edge, a plurality of such strips is provided. Preferably, the remainder of said strip remains immovable in the edge concerned during said coupling movement. Amongst others, such embodiment allows for fixedly connecting the strip to the floor panel concerned, or to the respective edge thereof. According to a particular possibility of the present important embodiment, said preferably resilient element as such consists of a rigid locking part, which is provided on the strip via a movable, preferably resilient, connection. Such possibilities can result in an extremely stable system, in which the starting position of the strip and its elements is unambiguously and/or precisely determined. Hereby, also an embodiment can be obtained in which, with an unlocking of the edges concerned, the strip and/or the elements thereof automatically will resume their starting position. Moreover, such positioning of the strip and/or the elements thereof can be maintained when the panel is subdivided perpendicularly to the strip concerned, for example, in order to obtain appropriate panels in a last row.

Preferably, said element or the strip, of which it forms part, in coupled condition extends exclusively at the edges concerned, and said element or the strip, in other words, is free from functional component parts, which are present or can be present at the remaining edges of the respective panels. When such element or strip is applied at the short edges of oblong panels, such element or strip, according to the present preferred embodiment, is free from parts extending along one or more of the long edges of the respective panels. In this manner, it can be obtained that possible coupling means present at the long edges do not interfere with the movement of the element of the invention.

Preferably, the respective element or the strip, of which it forms part, is made shorter than or maximum equally long as the length of the decor side at the respective edge. In this manner, too, it can be obtained that possible coupling means present at the other edges of the panel do not interfere with the movement of the element of the invention.

Preferably, the floor panel of the invention is made rectangular, and still better, the aforementioned pair of edges, where the aforementioned element is present, relates to a pair of short edges of this floor panel. In such case, said floor panel preferably is also provided with coupling means at the pair of long edges, wherein these coupling means then preferably can be provided in each other by means of a turning movement around the edge concerned. Preferably, then the coupling means at the pair of short edges are provided in each other by means of this same turning movement, or at least this is possible, by which a so-called fold-down movement or scissor-like movement is created.

Preferably, the invention is applied for connecting floor panels which substantially are made of wood or wood-like materials, whereas the aforementioned preferably resilient element or possibly the aforementioned strip is made on the basis of synthetic material. Preferably, this herein relates to an element or a strip which is manufactured by means of injection molding in a mold. Preferably, this element or this strip further also comprises components which contribute to the stability thereof. For example, this element or this strip also can comprise glass fiber or other fibers. Said wood-like material preferably comprises MDF or HDF (Medium Density Fiberboard or High Density Fiberboard).

With the same objective as with the first independent aspect, the present invention, according to a second independent aspect, also relates to a floor panel, which, at least at two opposite edges, is provided with coupling means allowing to couple two of such floor panels to each other at the respective edges, such that the respective floor panels, in the coupled condition, are locked in a vertical direction perpendicular to the plane of the coupled floor panels, as well as in a horizontal direction perpendicular to the respective edges and in the plane of the coupled floor panels, with the characteristic that the coupling means of said edges can be provided in each other by means of a turning coupling movement around an axis transverse to the respective edges, whereas it is impossible to bring the coupling means of said edges into each other via a purely downward coupling movement of the one floor panel in respect to the other floor panel. This means that for the installing person, this is impossible without auxiliary elements or auxiliary actions which are foreign to the downward coupling movement. As the possibility is eliminated to lock the floor panels at the respective edges by means of a purely downward coupling movement, new possibilities are created, which do not or only minimally affect the user-friendliness thereof. Indeed, it remains possible to interconnect the floor panels by means of a fold-down movement or scissor-like movement.

Preferably, at the respective edges use is made of a preferably resilient element, wherein this element preferably forms an obstruction for said purely downward coupling movement. Preferably, said element is gradually pushed away by means of said turning coupling movement, such that said obstruction is eliminated.

It is clear that the invention of the second aspect can be applied with the same type of floor panels as this is the case with the first aspect of the invention, such as with floor panels which are substantially composed of wood or wood-like materials, and/or with floor panels which comprise a thin top layer, such as a laminate top layer or veneer top layer. Further, it is clear that the characteristics of the first aspect and the second aspect can be combined in one and the same floor panel, inasmuch as they are not contradictory.

According to a third independent aspect, the invention aims at a method which allows manufacturing floor panels with coupling means in a smooth manner. To this aim, this invention relates to a method for manufacturing panels, wherein these panels, at least at two opposite edges, are provided with coupling means allowing to couple two of such floor panels at the edges concerned to each other, such that the respective floor panels in the coupled condition are locked in a vertical direction perpendicular to the plane of the coupled floor panels, as well as in a horizontal direction perpendicular to the respective edges and in the plane of the coupled floor panels, wherein the method comprises at least a step in which the panels are transported with a feeding speed or passage speed in the direction of the edges concerned and wherein, for forming at least a part of said coupling means at said edges, use is made of a cutting tool, which rotates around an axis which is substantially parallel to said edges.

The use of cutting tools which rotate around an axis which is substantially parallel to the edges is known as such, for example, from WO 2009/116926. One or more of such tools can be arranged in a so-called edge profiling machine (English: end tenoner), wherein the panels are transported at a feeding speed through the machine in the direction of, for example, a short pair of edges and are treated at these edges or borders by means of a plurality of machining tools. Herein, the feeding speed or passage speed can be situated between 10 and 200 meters per minute. In the case of the short edges, a speed of approximately 30 meters per minute is usual. The known arrangements of cutting tools rotating around an axis which is substantially parallel to the edges, however, have the disadvantage that starting and/or stopping the passage of the panels is rather difficult. The problems which occur are due to attaining too low a passage speed of the panels. With low speeds, the engagement of this type of cutting tools is suboptimal or even not optimal at all. Generally, working with this type of tools at low passage speed proves difficult.

The present invention offers a possibility of reducing or even excluding the herein above outlined problems with cutting tools which rotate around an axis which is substantially parallel to the edges. To this aim, the method of the third aspect shows the characteristic that said cutting tool performs a cutting treatment at the respective edges and during performing this cutting treatment moves in a direction opposite to the feeding of said panels. By this, it is achieved that the relative velocity between the cutting tool and the panel is higher than the passage speed of the panels. Preferably, this relative velocity is at least 5 percent higher than the feeding speed or passage speed and still better at least 10 percent higher.

Preferably, the cutting tool relates to a so-called screw cutting tool, for example, of the type such as described in WO 2009/116926. Herein, this relates to a cutting tool having the shape of a conical worm wheel, wherein the cutting edges follow a spiraled path on the surface of the cutting tool and wherein these cutting edges show a gradually increasing engagement at the panel as they become located closer to the basis of said conical worm wheel.

Preferably, the respective cutting tool is applied at least for treating one edge of a pair of short opposite edges of a rectangular oblong panel. For example, this relates to the realization of a portion of a male coupling part, which preferably can participate in a so-called fold-down movement or scissor-like movement.

It is clear that the method possibly can be applied for realizing the panels of the first and/or the second aspect and also can be applied for realizing the panels of the state of the art, such as for realizing the panels described in WO 2009/116926.

With the same objective as in the third aspect, the invention, according to a fourth independent aspect, also relates to a method for manufacturing panels, wherein these panels, at least at two opposite edges, are provided with coupling means allowing to couple two of such panels or floor panels at the edges concerned to each other, such that the respective floor panels in the coupled condition are locked in a vertical direction perpendicular to the plane of the coupled floor panels, as well as in a horizontal direction perpendicular to the respective edges and in the plane of the coupled floor panels, wherein the method comprises at least a step in which the panels are transported one by one, however, with mutual panel-free intermediate spaces, at a feeding speed in the direction of the respective edges, and wherein, for forming at least a part of said coupling means, use is made of a cutting tool, which rotates around an axis, which axis is substantially parallel to said edge, with the characteristic that at least two of said panels define a mutual intermediate space, which is at least so large that this intermediate space allows that the aforementioned cutting tool can be situated therein without an engagement of the cutting tool in the panels which define the aforementioned mutual intermediate space.

By providing said mutual intermediate space, a space is obtained in which the cutting tool can be located when starting or stopping said feeding speed or passage speed of the panels. In the also above-described edge profiling machines, such mutual intermediate space can be adjusted by means of the adjustment of the mutual distance between the carrier cams which are situated on the transport device of the machine and transport the panels through the machine. Preferably, an edge profiling machine is used with a transport device consisting of a chain drive.

The invention of the fourth aspect can be realized according to various possibilities.

According to a first possibility, the majority, or still better all of the mutual intermediate spaces between panels show the feature that they are so large that this intermediate space allows that said cutting tool can be situated therein without an engagement of the cutting tool in the panels which define said mutual intermediate space. It is self-evident that by such arrangement, a start and/or stop of the passage of the panels can be achieved in a very flexible manner.

According to a second possibility, only some, this means, for example, less than three or still better only one of the mutual intermediate spaces shows the feature that it is so large that this intermediate space allows that said cutting tool can be situated therein without an engagement of the cutting tool in the panels which define said mutual intermediate space. According to this second possibility, the respective intermediate space can be made relatively large, for example, so large that even at least a double-sized cutting tool can be situated therein. In such case, a less critical start and/or stop of the passage of the panels can be achieved.

According to a third possibility, said mutual intermediate space is performed adaptively, namely in such a manner that it fulfills the conditions of the fourth aspect when starting and/or stopping the passage of the panels, however, in full operation does not show this feature any longer.

According to a fourth possibility, said mutual intermediate space is realized immediately before starting and/or stopping, for example, by means of the technique of said third possibility, or, for example, in that a panel position, which is used in full operation, is emptied when starting or stopping the passage.

When the operation takes place in accordance with the third and/or the fourth aspect of the invention, a possible start and/or stop of the passage of the panels preferably is realized in function of the position of the fed panels. In this manner, a controlled start and/or stop can be realized, for example, in such a manner that the respective cutting tool always is stopped in the mutual space, obtained according to the fourth aspect, between the panels.

With the same objective as with the third and fourth aspect, the present invention according to a fifth independent aspect also relates to a method for manufacturing panels, wherein these panels, at least at two opposite edges, are provided with coupling means allowing to couple two of such panels or floor panels at the edges concerned to each other, such that the respective floor panels in the coupled condition are locked in a vertical direction perpendicular to the plane of the coupled floor panels, as well as in a horizontal direction perpendicular to the respective edges and in the plane of the coupled floor panels, wherein the method comprises at least a step in which the panels are transported one by one at a feeding speed in the direction of the respective edges, and wherein, for forming at least a part of said coupling means, use is made of a cutting tool, which rotates around an axis, which axis is substantially parallel to said edge, with the characteristic that said cutting tool, measured in a direction parallel to the edges concerned, shows a larger length than the length of these edges.

Due to the fact that the respective cutting tool is made relatively long, it is obtained that the incremental engagement of the cutting edges can be restricted. This means that the amount of material, which must be removed by each cutting edge of the tool, can be minimized. This is of particular interest in the case that use is made of one or more of the also above-described screw-type tools. With such tools, the above-discussed increasing engagement provides for that each subsequent cutting edge removes an incremental amount of extra material. By making the cutting tool longer than the edge to be treated, a longer spiral-shaped path of cutting edges is obtained, such that the number of cutting edges is increased and, as a result, the incremental volume of material to be machined will be reduced. Possibly, the cutting tool can be brought into engagement with a plurality of successive panels at the same time.

With the intention of better showing the characteristics of the invention, hereafter, as an example without any limitative character, several preferred embodiments are described, with reference to the accompanying drawings, wherein:

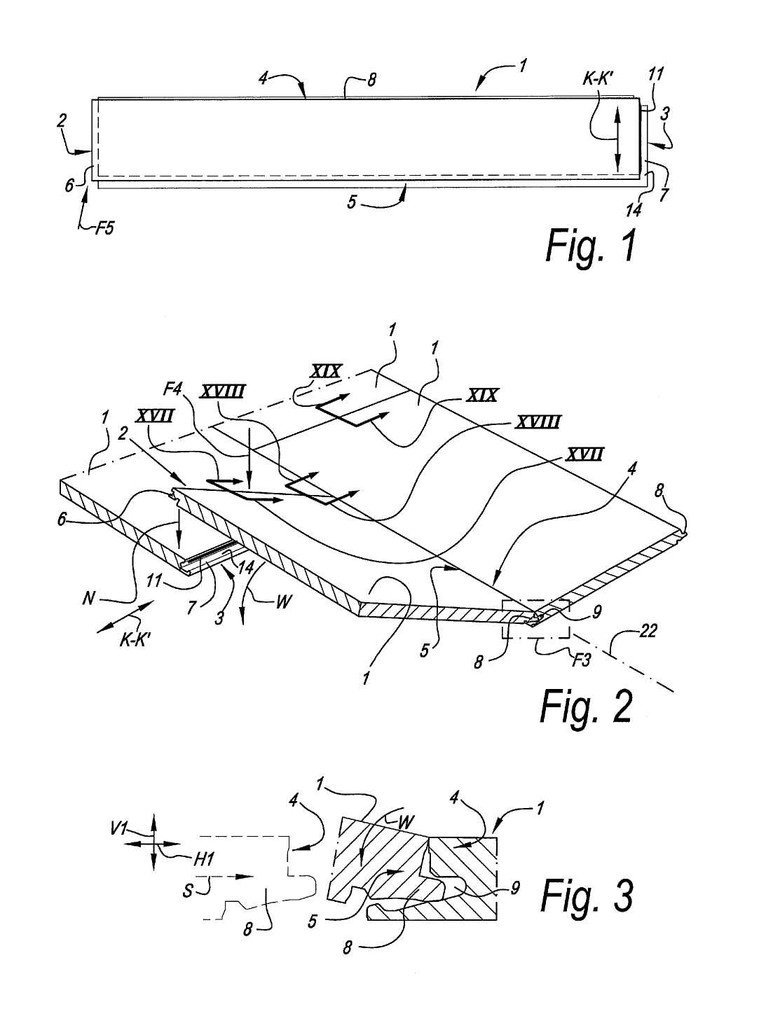

FIG. 1 represents a floor panel with the characteristics of, amongst others, the first aspect of the invention;

FIG. 2 in perspective represents how the floor panel of FIG. 1, by means of a fold-down movement, can be locked together with a plurality of similar floor panels;

FIG. 3 represents a view on the area indicated by F3 in FIG. 2;

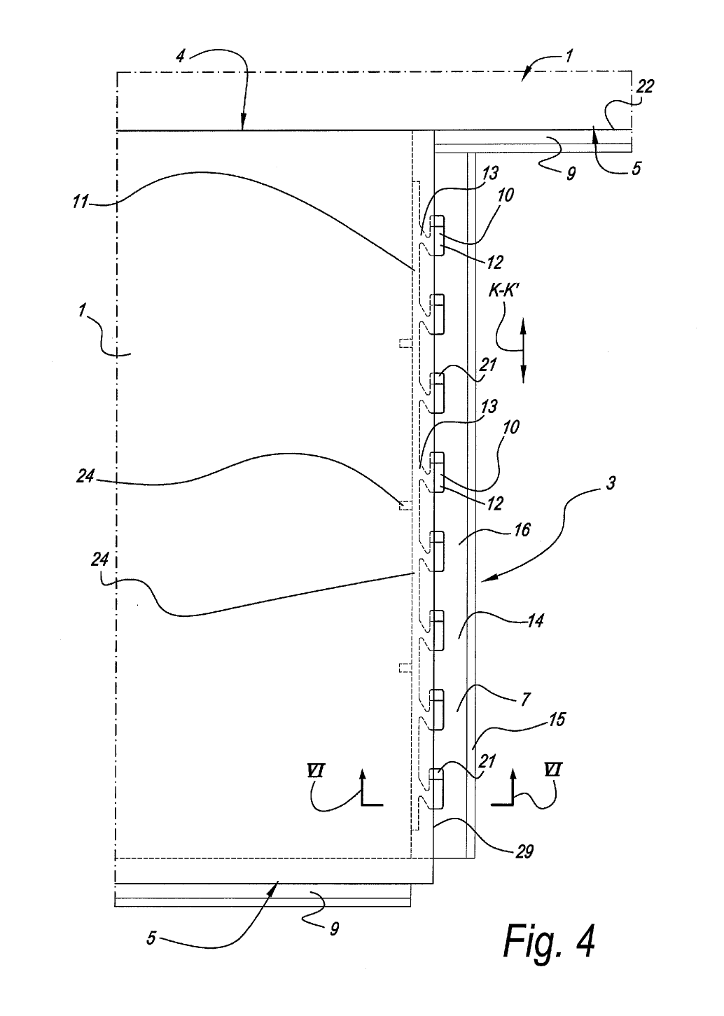

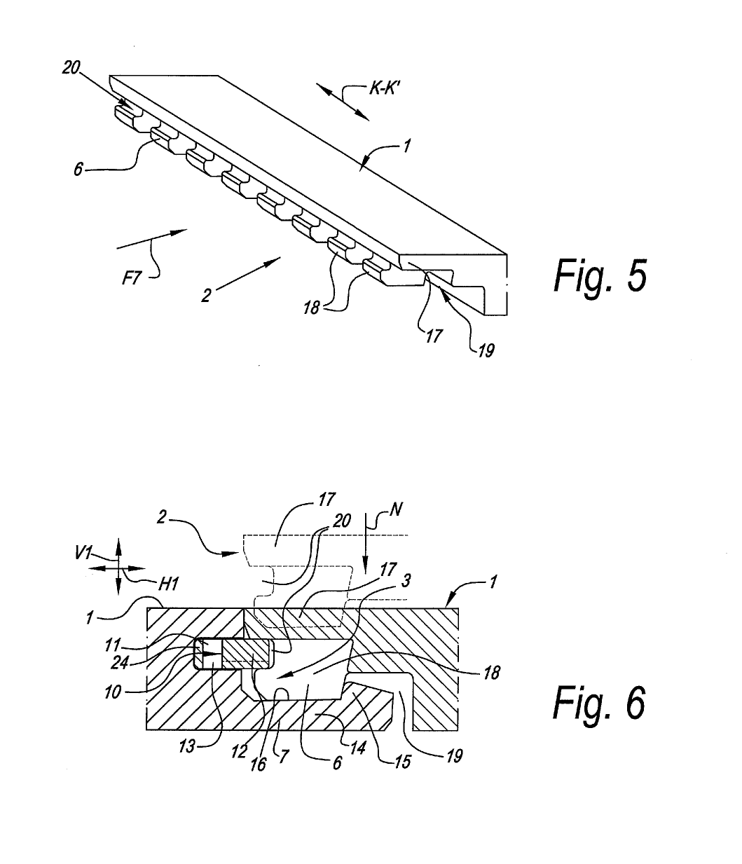

FIGS. 4 and 5 represent a view according to the arrows F4 indicated in

FIG. 2 and arrow F5 indicated in FIG. 1, respectively;

FIG. 6 in cross-section represents a view according to the line VI-VI indicated in FIG. 4;

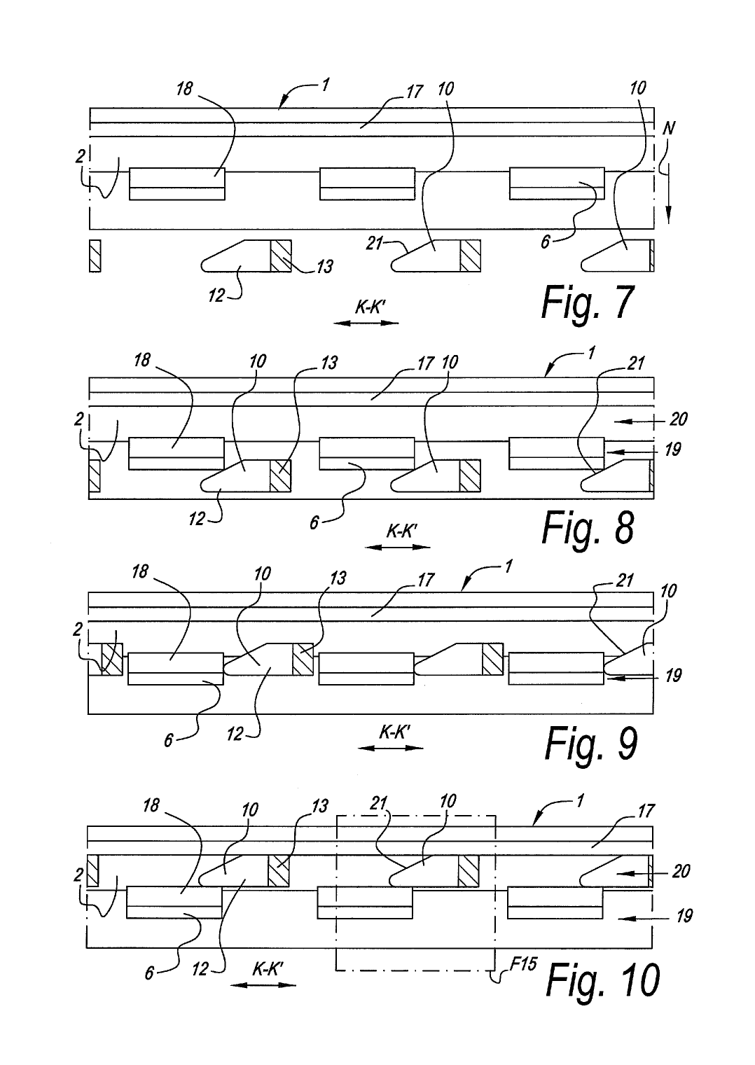

FIGS. 7 to 10 represent views according to the arrow F10 indicated in FIG. 5 during the performance of a purely downward coupling movement at the represented edges;

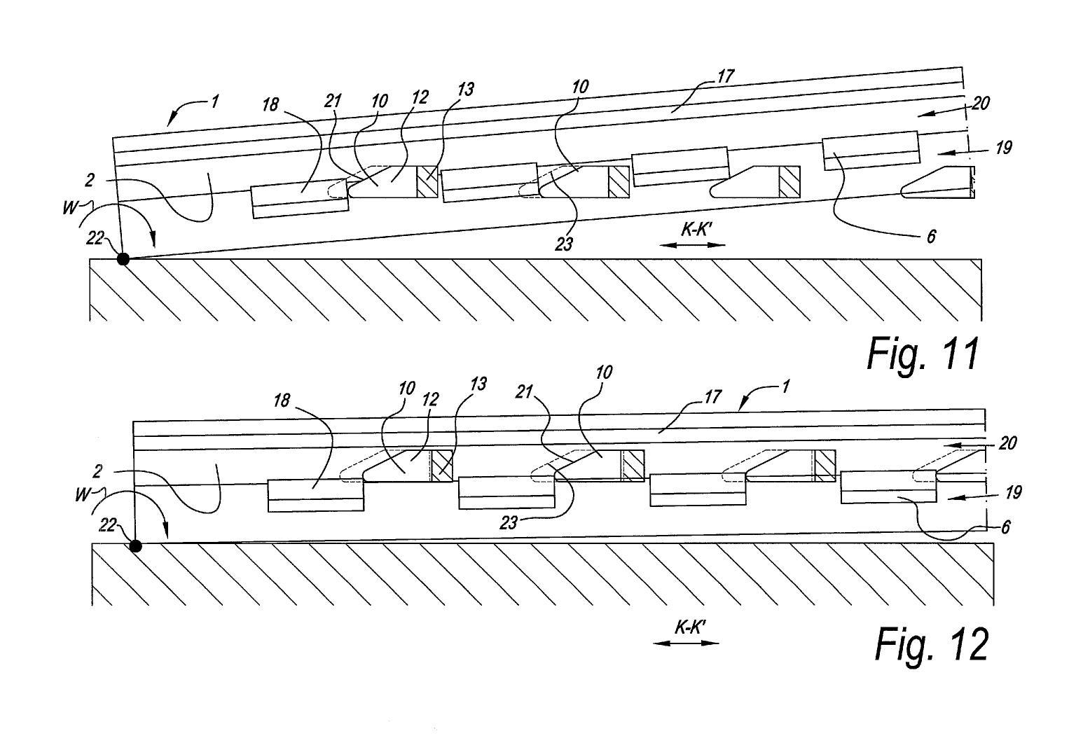

FIGS. 11 and 12 represent a similar view during the performance of a fold-down movement at the represented edges;

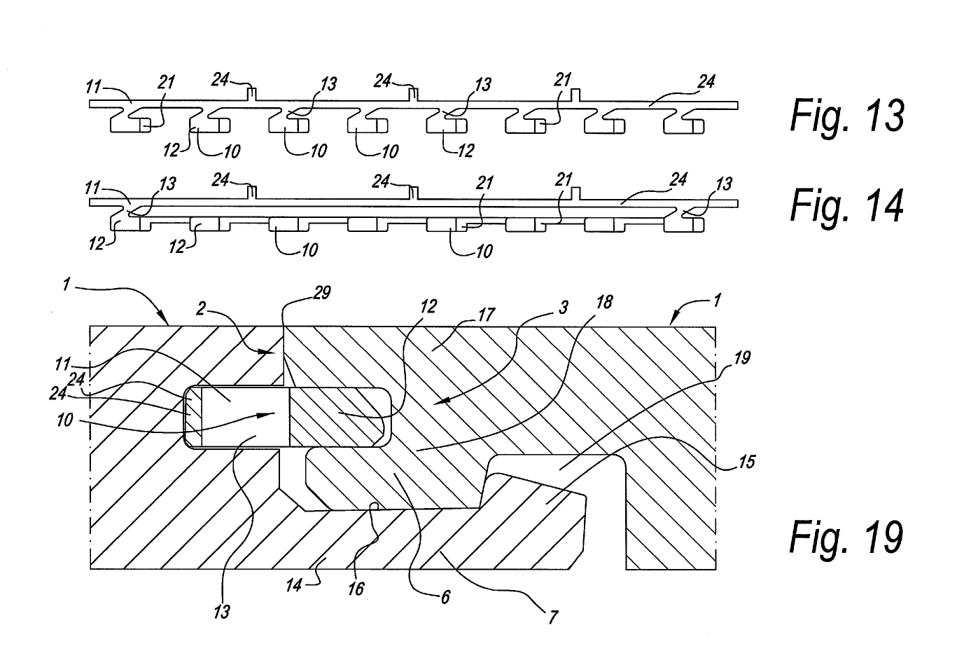

FIG. 13 represents a view on the strip applied therewith;

FIG. 14 represents a similar view on a variant of such strip;

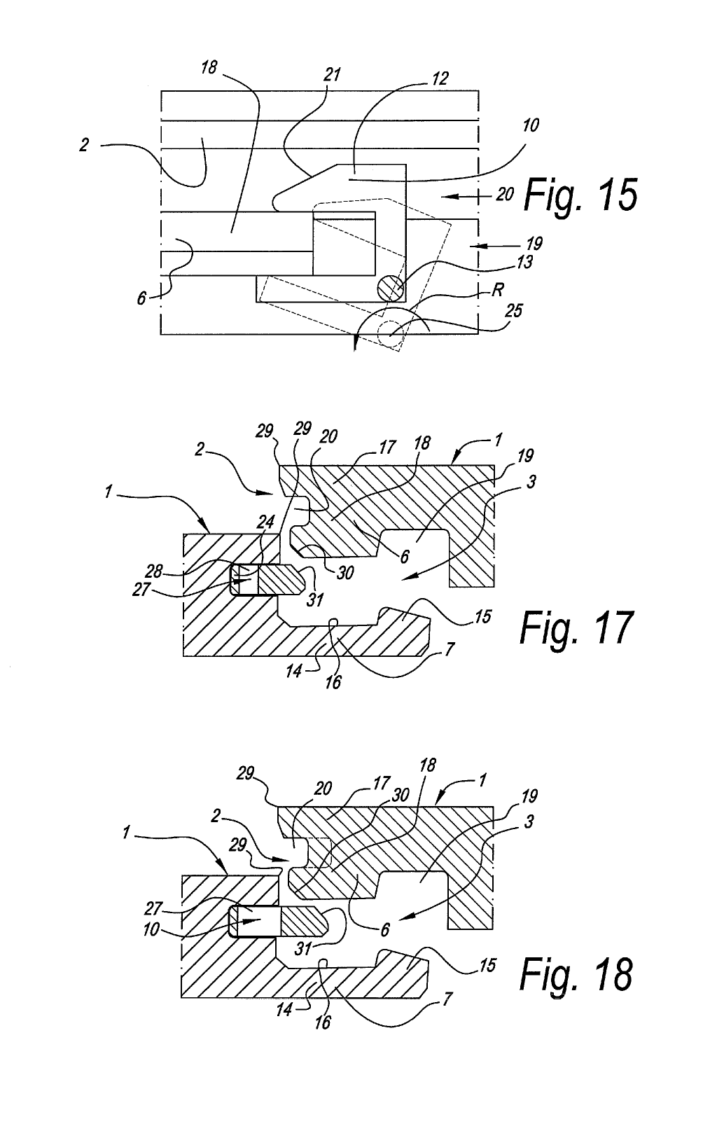

FIG. 15 represents a view on the area indicated by F15 in FIG. 10, for a variant;

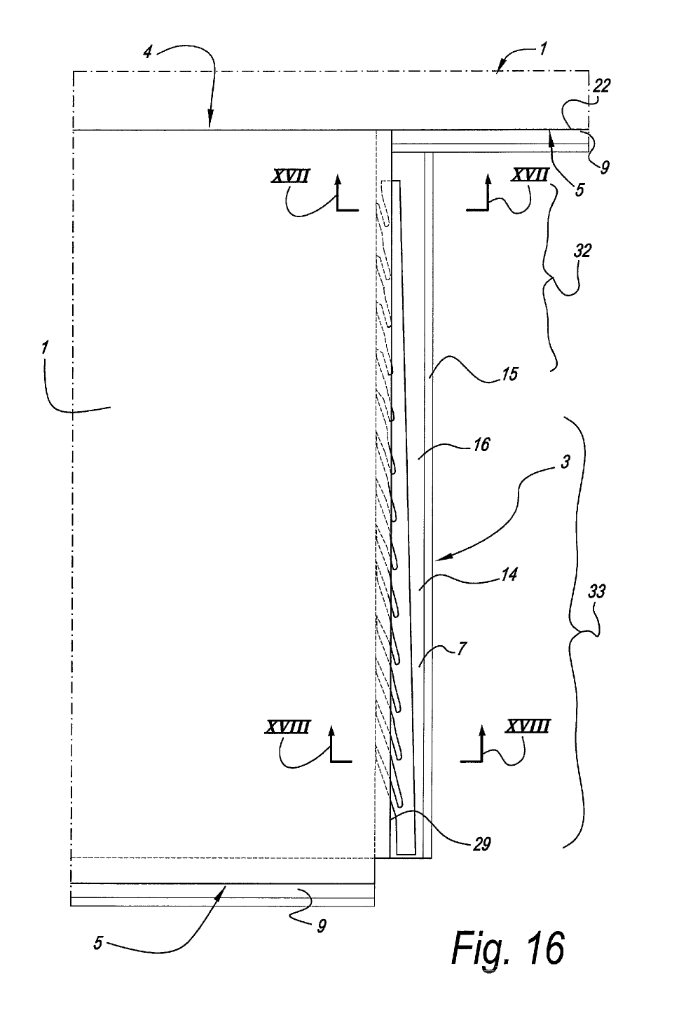

FIG. 16, in a view similar to that of FIG. 4, represents a floor panel with, amongst others, the characteristics of the second aspect of the invention;

FIGS. 17 to 19, for the variant of FIG. 16, represent views according to the lines XVII-XVII, XVIII-XVIII and XIX-XIX, respectively, shown in FIG. 2; and

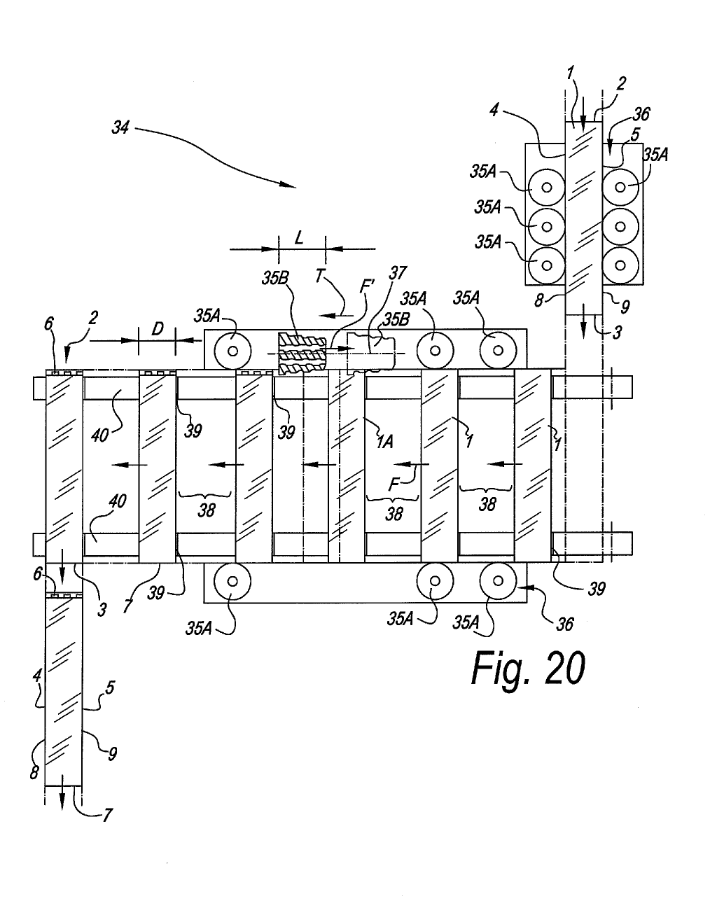

FIG. 20 schematically represents some steps in a method having the characteristics of, amongst others, the third aspect of the invention.

FIG. 1 represents a rectangular floor panel 1 with a pair of short opposite edges 2-3 and a pair of long opposite edges 4-5. At both pairs of edges 2-3, 4-5, the floor panel 1 is provided with coupling means or coupling parts 6-7-8-9 allowing to couple two of such floor panels 1 to each other at the respective edges 2-3, 4-5.

FIG. 2 represents that said coupling means or coupling parts 8-9 allow that the floor panel 1, by means of a turning movement W around the pair of long edges 4-5, can be locked together with a similar floor panel 1. Said turning movement W around the long pair of edges 4-5 results in a downward movement N at the pair of short edges 2-3.

FIG. 3 illustrates that by means of the turning movement W in the coupled condition of the long edges 4-5, a locking is obtained in a vertical direction V1 perpendicular to the plane of the coupled floor panels 1, as well as in a horizontal direction H1 perpendicular to the respective edges 4-5 and in the plane of the coupled floor panels 1. Further, FIG. 3 represents that in this case at the long pair of opposite edges 4-5 coupling means or coupling parts 8-9 are applied, which at the same time allow a coupling by means of a substantially horizontal shifting movement S of the floor panels 1 towards each other.

FIG. 4 represents a view on one edge 3 of the opposite pair of short edges 2-3. The edge 3 concerned is provided with a female coupling part 7, which comprises resilient elements 10. These elements 10 form part of a separate strip 11, which is provided at the respective edge 3. The elements 10 as such each consist of a rigid locking part 12, which is provided on said strip 11 by means of a resilient connection 13. For the rest, said female coupling part 7 substantially consists of a lower lip 14 protruding at the underside of the floor panel 1, which lip is provided with an upwardly-directed hook-shaped part 15, which borders a recess 16 in said lower lip 14.

FIG. 5 represents a view on the other edge 2 of said opposite pair of short edges 2-3. The respective edge 2 is provided with a male coupling part 6. Herein, the male coupling part 6 substantially consists of an upper lip 17, which protrudes at the upper side of the floor panel 1 and which is provided with a series of downwardly directed hook-shaped parts 18, which border a recess 19 in said upper lip 17. It is noted that such coupling part 6 can be manufactured, for example, by means of methods similar to those described in WO 2009/116926.

FIG. 6 represents that in a coupled condition of two of such floor panels 1, the male coupling part 6 is provided in the female coupling part 7 and that the obtained cooperation between these coupling parts 6-7 results in a locking between the respective edges 2-3 in a vertical direction V1 as well as in a horizontal direction H1. For obtaining the locking in horizontal direction H1, said hook-shaped parts 15-18 and recesses 16-19 cooperate with each other. The locking in vertical direction V1 is provided substantially by said elements 10, more particularly, the rigid locking parts 12 thereof. For this purpose, the latter cooperate with a locking groove 20 extending transverse to said horizontal direction.

FIG. 7 schematically represents the beginning of the coupling of the short edges 2-3, when it is performed by means of a purely downward movement N.

FIG. 9 represents a further moment in time during said coupling. At the represented moment, the first contact is made between said downwardly directed hook-shaped parts 18 of the male coupling part 6 and said resilient elements 10, more particularly the rigid locking parts 12 thereof. After this first contact, by the inclined part 21, which in this case is provided on the elements 10, a movement of the elements 10 in the direction K of the short edges 2-3 is caused. Instead of or in combination with such inclined parts 21, inclined parts may also be provided at the underside of said downwardly directed hook-shaped parts 18. Instead of inclined parts 21, technically equivalent guiding surfaces may be applied.

FIG. 9 represents a still further moment during coupling. Herein, a moment is represented at which said elements 10 have undergone their maximum displacement. Due to the fact that the locking parts 12, which as such are rigid, are resiliently connected to the strip 11, the elements 10 at that moment have an amount of potential energy. When the male coupling part 6 is moved further downward, the elements 10 shall make use of said energy in order to engage in said locking groove 20, in order to provide in this manner at least partially for said locking in the vertical direction V1 between the respective edges 2-3. The engagement takes place by means of a movement K′ of the elements 10 in the direction of the respective edge 2-3, however, in the opposite sense in comparison to the movement K which was created at the moment represented in FIG. 8.

FIG. 10 represents the obtained coupled condition at the end of said coupling movement, wherein said elements 10 are located in said locking groove 20.

FIG. 11 schematically represents a moment in time of a coupling by means of a turning coupling movement W around an axis 22 transverse to the respective short edges 2-3. Hereby, automatically a downward movement N at the short edges 2-3 of the one floor panel in respect to the other is obtained. This may relate, for example, to a turning movement W, such as the one discussed and represented by means of FIG. 2, namely, a so-called fold-down movement or scissor-like movement. In dashed line 23, the original position of the elements 10 is represented. Hereby, it is made clear that the strip 11, which is applied in the example, allows that the various elements 10 move independently from each other and thus may undergo a mutually differing displacement.

FIG. 12 largely represents the same as FIG. 11, however, for a further advanced turning coupling movement W. When continuing the turning, a condition is obtained identical to that from FIG. 10.

FIG. 13 again represents the strip which is applied in the examples of the preceding figures. The strip 11 is provided with attachment parts 24, by which they can be attached to the respective edge 3. Possibly, the attachment parts 24 of the strip 11 can be glued to the edge concerned. Preferably, these attachment parts 24 of the strip 11 remain immovable in the respective edge 3 during said coupling movement N.

FIG. 14 represents a possible variant of such strip 11, wherein the elements 10 themselves are not able to move independently from each other, but all move together, as they are rigidly interconnected. Such strip 11, however, still may allow a locking by means of a purely downward movement N and by means of a fold-down movement W.

From the description of the above FIGS. 1 to 14, it is clear that the embodiments represented there also show the features of various preferred embodiments mentioned in the introduction. Namely, the strip 11 is performed such that the edges 2-3 concerned and the coupling means 6-7 integrated there independently lead to the movements K-K′ of said elements 10. Further, the strip 11 extends exclusively at the edges 2-3 concerned, and the strip 11 is free from functional component parts at the location of the other pair of edges 4-5. Namely, the strip 11 represented here is made shorter than the length of the decor side at the edges 2-3 concerned.

In FIGS. 11 and 12, amongst others, it is clear that the first movement of the elements 10 takes place in a direction K towards the female coupling part 9 of the long edges 5, whereas the second movement takes place in a direction K′ towards the male coupling part 8 of the long edges 4.

FIG. 15 represents another variant, wherein the movement performed by the element 10 during the coupling movement, substantially relates to a rotational movement R, in this case, around an axis 25 transverse to the respective edges 2-3. In the example, this rotational movement R is initiated by a contact between the downwardly directed hook-shaped part 18 and a maneuvering part 26 of said element 10. It is noted that this example also makes clear that the element 10 does not necessarily have to be resilient and that the element does not necessarily have to perform two movements in opposite sense during performing of the coupling movement. However, it is clear that such rotational movement R can also be performed with resilient elements 10 and that two rotational movements R in opposite sense are also possible.

FIG. 16 represents a female coupling part 7 of a floor panel 1 showing the characteristics of the second aspect of the invention. The respective edge 3 is provided with a female coupling part 7, which comprises a resilient element 27. In this case, this element 27 consists of a separate strip 28, which is provided at the respective edge 3.

As becomes clear from FIG. 17, the aforementioned female coupling part 7 further also comprises a lower lip 14 protruding at the underside of the floor panel 1 and which is provided with an upwardly extending hook-shaped part 15, which borders a recess 16 in said lower lip 14. FIG. 17 further also represents the male coupling part 6 of the opposite edge 2, which can be provided in the aforementioned female coupling part 7. The male coupling part 6 comprises an upper lip 17, which protrudes at the upper side of the floor panel 1 and which is provided with a downwardly directed hook-shaped part 18, which borders a recess 19 in said upper lip 17.

The floor panels 1 represented in FIGS. 16 and 17 show the characteristic that the male and female coupling parts 6-7 represented there can be provided in each other by means of a turning coupling movement W around an axis 22 transverse to the respective edges 2-3, whereas is impossible to bring the coupling means or coupling parts 6-7 of the same edges 2-3 into each other by means of a purely downward coupling movement N of the one floor panel 1 in respect to the other floor panel 1.

In the cross-section represented in FIG. 16, it seems possible to provide the male coupling part 6 in the female coupling part 7 by a purely downward movement N, when the respective floor panels 1 are located with their upper edges 29 approximately vertically one above the other. This possibility is reflected in the fact that the guiding surfaces 30-31 of the resilient element 27 as well as the underside of said downwardly directed hook-shaped part 18 are positioned at least partially vertically above one another, such that, when a downward coupling movement N is continued, they can come into mutual contact. This contact possibility leads to that the downwardly directed hook-shaped part 18 pushes the aforementioned element 27 aside and in this manner can enter the recess 19 of the female coupling part 7. Generally, the edge 3 concerned shows the possibility of engaging the male coupling part 6 in the female coupling part 7 at least over a portion 32 of the length of this edge 3, wherein this portion 32 is situated next to the axis 22 around which said turning coupling movement W has to be performed.

As becomes clear from FIG. 18, it is impossible to provide the male coupling part 6 in the female coupling part 7 by means of a purely downward movement N, because the aforementioned element 27 forms an obstruction for performing a purely downward coupling movement N. In this case, this obstruction is caused by the fact that said guiding surfaces 30-31 are not at least partially positioned vertically above one another. Due to the fact that a situation such as that represented in FIG. 18 preferably exists at least over a portion 33 of the length of the respective edge 3, it is impossible to have the floor panels 1 cooperate with each other at the edge 3 concerned by means of a purely downward movement N. Preferably, the respective portion 33 of this edge 3 is situated, such as here, distally from the axis 22 around which said turning coupling movement W has to be performed.

Due to the fact that, in the example, it is possible to push the resilient element 27 away on a portion 32 of the edge 3 proximally in respect to the aforementioned axis 22, it is obtained with such turning coupling movement W that this element 27, when the coupling proceeds, gradually is pushed farther and farther away. Hereby, the obstruction, which did extend over said distal portion 33 of this edge 3, disappears and there, too, the male coupling part 6 can be provided in the female coupling part 7 by means of the downward movement N resulting from the fold-down movement W.

Further, FIG. 18 represents in dashed line that the locking groove 20 is or is not made deep enough in order to allow at least a complete relaxation of the resilient element 10. Possibly, the depth of the locking groove 20, too, can be performed varying over the length of the edge 3.

FIG. 19 shows that over the aforementioned distal portion 33 a large engagement of the resilient element 27 can be obtained and that therefore at least over this portion 33 a strong locking in the vertical direction V1 can be obtained.

FIG. 20 schematically represents a top view on a milling line 34 which can be applied in a method having the characteristics of the third, fourth and/or fifth aspect.

As represented, this may relate to a method for manufacturing panels 1, wherein these panels 1, at least at two opposite edges 2-3, are being provided with coupling means 6-7. In this case, the panels 1, at both pairs of opposite edges 2-3-4-5, are being provided with coupling means 6-7-8-9 allowing to couple two of such panels or floor panels 1 to each other at the edges 2-3-4-5 concerned, such that the respective floor panels, in the coupled condition, are locked in a vertical direction V1 perpendicular to the plane of the coupled floor panels 1, as well as in a horizontal direction H1 perpendicular to the edges 2-3-4-5 concerned and in the plane of the coupled panels or floor panels 1.

In the example of FIG. 20, rectangular floor panels 1 are manufactured, wherein these panels 1 comprise a pair of short edges 2-3 and a pair of long edges 4-5. The coupling means 8-9 applied at the pair of long edges 4-5 can be, for example, of the type as represented in FIG. 3, or of another type of coupling means, which preferably is made in one piece with the panel 1. The cooperation between the coupling means 6-7-8-9 of the long edges 4-5 and the short edges 2-3 preferably allow a coupling by means of a fold-down or scissor-type movement. For example, this may relate to coupling means 6-7 of the type known from WO 2009/116926 or WO 2007/004960, wherein the final vertical locking between these panels 1 does not happen automatically, but only is obtained when installing another row, such as explained in the introduction. However, this may also relate to coupling means 6-7 having the characteristics of said first and/or second aspect. Preferably, the male coupling part 6 shows a discontinuous shape at the aforementioned short edges 2, said shape being comparable to that from FIG. 5.

As FIG. 20 represents, the coupling means 6-7-8-9 of the pair of long edges 4-5 as well as of the pair of short edges 2-3 are realized by moving the floor panels 1 at a feeding speed F along the cutting tools 35A-35B of a milling line 34, in this case a milling line 34 consisting of two respective milling machines or edge profiling machines 36. Realizing profiled edge regions in the form of coupling means at the edge of panels is known as such, for example, from WO 97/47834. Herein, usually milling tools 35A are applied, which rotate around an axis which is directed transverse to the panel surface.

In this case, the particularity of the method of the third aspect is illustrated by means of the short edge 2 and consists in that the method comprises a step wherein, for forming at least a part of the coupling means 6, in this case the male coupling part 6 at the short edge 2, use is made of a cutting tool 35B, which rotates around an axis 37, which substantially is parallel to said short edges 2-3. Herein, said cutting tool 35B performs a cutting movement at the respective edge 2 and, during cutting, moves in a direction F′ opposed to the feeding F of the respective panel 1 or floor panel. Herein, the panel 1A is represented in solid line while it moves towards said cutting tool 35B. In dashed line, the position of the panel 1A as well as of the cutting tool 35B is represented after the cutting treatment has been completed. The arrow F′ illustrates the movement of the cutting tool 35B in opposed sense of the feeding speed F of the panels 1. The arrow T represents that the cutting tool 35B, at the end of the cutting treatment, then can move back to its starting position, preferably without the cutting tool 35B catching up with the already treated panel 1A.

In FIG. 20, a so-called screw-type tool 35B is applied, for example, of the type such as described in WO 2009/116926, namely, in the form of a conical worm wheel.

FIG. 20 further also represents the particular characteristic of the fourth aspect of the invention, namely, that the panels 1 are transported one by one, however, with mutual panel-free intermediate spaces 38, and that at least two of these panels 1 define a mutual intermediate space 38, which is at least so large that this intermediate space 38 allows that the aforementioned cutting tool 35B can be situated therein without an engagement of the cutting tool 35B in the panels 1 which define the aforementioned mutual intermediate space 38. As represented, in this case the intermediate spaces 38 are determined by carrier cams 39, which are located on the transport device 40, in this case, a chain drive.

FIG. 20 further also represents the particular characteristic of the fifth aspect of the invention, namely that the cutting tool 35B, which rotates around an axis 37, which substantially is parallel to the edge 2 to be treated, measured in a direction parallel to the edge 2 concerned, extends over a larger distance than the length D of the edge 2 to be treated.

It is clear that the feeding movement F of the panels 1 in the edge profiling machine 36 preferably is continuous or almost continuous. For example, it may show the velocities mentioned in the introduction. Preferably, the opposite movement of the cutting tool 35B also is continuous, anyhow, at least when this cutting tool 35B engages in the edge 2. Further, it is clear that the movements F′-T of the cutting tool 35B preferably proceed synchronized with the passage of the panels 1. Still better, the movements F′-T are controlled actively, such that they are adjusted to the passage movement F of the panels 1, as described above.

It is clear that the innovative coupling means or coupling parts of the first and/or of the second aspect can be applied as well for coupling other panels than floor panels, such as, for example, for coupling ceiling panels, wall panels or furniture panels. It is also clear that the different methods of the invention can also be applied with any type of panels.

Further, it is clear that the separate elements, resilient elements or other elements, according to the invention, do not necessarily have to be located at the female coupling part. To the expert, it is clear that equivalent embodiments can be achieved, wherein such element is situated at least at the male coupling part.

The present invention is in no way limited to the embodiments described herein; on the contrary, such methods and panels can be realized according to various variants, without leaving the scope of the present invention.

1. A floor panel, which, at least at two opposite edges, is provided with coupling means allowing to couple two of such floor panels to each other at the respective edges, such that the respective floor panels, in the coupled condition, are locked in a vertical direction perpendicular to the plane of the coupled floor panels, as well as in a horizontal direction perpendicular to the respective edges and in the plane of the coupled floor panels, wherein the coupling means of said edges can be provided in each other by means of a turning coupling movement around an axis transverse to the respective edges, whereas it is impossible to provide the coupling means of said edges into each other via a purely downward coupling movement of the one floor panel in respect to the other floor panel.

2. The floor panel according to claim 1, wherein at the edges concerned, use is made of a resilient element, wherein this resilient element forms an obstruction for said purely downward coupling movement.

3. The floor panel according to claim 2, wherein said resilient element gradually is pushed away by means of said turning coupling movement, such that said obstruction is eliminated.

4. A floor panel, which, at least at two opposite edges, is provided with coupling means allowing to couple two of such floor panels to each other at the respective edges, such that the respective floor panels, in the coupled condition, are locked in a vertical direction perpendicular to the plane of the coupled floor panels, as well as in a horizontal direction perpendicular to the respective edges and in the plane of the coupled floor panels wherein the locking in at least one of the aforementioned directions is obtained by at least an element which preferably is resilient and, during the coupling movement, moves in the direction of the edges concerned.

5. The floor panel according to claim 4, wherein the aforementioned resilient element in the coupled condition provides at least partially for said locking in vertical direction.

6. The floor panel according to claim 4, wherein the aforementioned coupling means of said two opposite edges substantially are made as a male coupling part and a female coupling part, wherein the male coupling part is provided in the female coupling part during the coupling movement.

7. The floor panel according to claim 4, wherein said coupling movement relates to a downward movement (N) of the one floor panel (1) in respect to the other floor panel (2).

8. The floor panel according to claim 4, wherein said resilient element during the coupling movement moves twice in the direction of the edge concerned.

9. The floor panel according to claim 4, wherein the resilient element is connected to one of the aforementioned edges and that, during the coupling movement, it engages in a locking groove, which latter is realized transverse to said horizontal direction.

10. The floor panel according to claim 4, wherein said resilient element forms part of a separate strip, which is provided at one of the edges of the floor panel.

11. The floor panel according to claim 10, wherein said strip is provided with a plurality of such resilient elements.

12. The floor panel according to claim 10, wherein the remainder of said strip remains immovable in the respective edge during said coupling movement.

13. The floor panel according to claim 10, wherein the aforementioned resilient element as such consists of a rigid locking part, which is provided on the strip via a resilient connection.

14. The floor panel according to claim 4, wherein said resilient element provides at least partially for said locking in horizontal direction.

15. The floor panel according to claim 4, wherein this floor panel is made rectangular and that the aforementioned pair of edges relates to a pair of short edges.

16. The floor panel according to claim 15, wherein said floor panel is also provided with coupling means at the pair of long edges, wherein these coupling means preferably can be provided in each other by means of a turning movement around the respective edge.

17. The floor panel according to claim 16, wherein the coupling means at the pair of short edges can be provided in each other by means of the same turning movement.

18. The floor panel according to claim 4, wherein the floor panel substantially is composed of wood or wood-like materials, whereas said resilient element is manufactured on the basis of synthetic material.

19. Method for manufacturing panels, wherein these panels, at least at two opposite edges, are being provided with coupling means allowing to couple two of such panels or floor panels at the edges concerned to each other, such that the respective floor panels in the coupled condition are locked in a vertical direction perpendicular to the plane of the coupled floor panels, as well as in a horizontal direction perpendicular to the respective edges and in the plane of the coupled floor panels, wherein the method comprises at least a step in which the panels are transported with a feeding speed in the direction of the edges concerned and wherein, for forming at least a part of said coupling means at said edges, use is made of a cutting tool which rotates around an axis which is substantially parallel to said edges, wherein the aforementioned cutting tool performs a cutting treatment at the edges concerned and, during performing this cutting treatment, moves in a direction opposed to the feeding of said panels.

20. (canceled)

21. (canceled)
